(19) United States
(12) Patent Application Publication
(10) Pub. No.: US 2019/0177576 A1
(43) Pub. Date: Jun. 13, 2019

(54) ADHESIVE FILM

(71) Applicant: SAINT-GOBAIN PERFORMANCE PLASTICS CORPORATION, Solon, OH (US)

(72) Inventors: Kyle J. KILLAM, Bennington, VT (US); Joseph B. MACDONALD, Hoosick Falls, NY (US); Nirmal PATEL, Bennington, VT (US); Fei WANG, Stoneham, MA (US); Donald J. BEAUDRY, Needham, MA (US); Jun JIA, Newton, MA (US)

(21) Appl. No.: 16/323,835

(22) PCT Filed: Aug. 8, 2017
(86) PCT No.: PCT/US17/45930

§ 371 Date: Feb. 7, 2019

Related U.S. Application Data
(60) Provisional application No. 62/376,760, filed on Aug. 18, 2016.

(51) Int. Cl. C09J 7/21; C09J 177/00; C09J 7/25

(52) U.S. Cl. CPC C09J 7/21; C09J 177/00; C09J 7/25; C09J 2205/114; C09J 2477/006; C09J 2427/006; C09J 2427/001; C09J 2423/04; C09J 2431/00; C09J 2400/225; C09J 2400/221; C09J 2475/00; C09J 2453/00; C09J 2400/263

(57) ABSTRACT

An adhesive film can include a barrier layer and an adhesive layer. In an embodiment, the barrier layer can have a melting temperature of at least 230° C. and the adhesive layer having a melting temperature of no greater than 200° C. In an embodiment, an article can include the adhesive film bonded to a substrate.

### FIELD OF THE DISCLOSURE

The present disclosure relates to adhesive films.

### BACKGROUND

There exists a need for improved adhesive films.

### BRIEF DESCRIPTION OF THE DRAWINGS

Embodiments are illustrated by way of example and are not limited in the accompanying figures.

FIG. 1 includes an illustration of an adhesive film according to an embodiment described herein.

FIG. 2 includes an illustration of an article including the adhesive film according to an embodiment described herein.

FIG. 3 includes an illustration of an article including an adhesive film overlying a zipper tape according to an embodiment described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE PREFERRED EMBODIMENT(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

As used herein, the term melting temperature refers a melting temperature determined using differential scanning calorimetry (“DSC”), according to ASTM D3418-15.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the adhesive film arts.

The adhesive film described herein can exhibit a combination of a relatively low bonding temperature and a relatively high heat resistance. The concepts are better understood in view of the embodiments described below that illustrate and do not limit the scope of the present invention

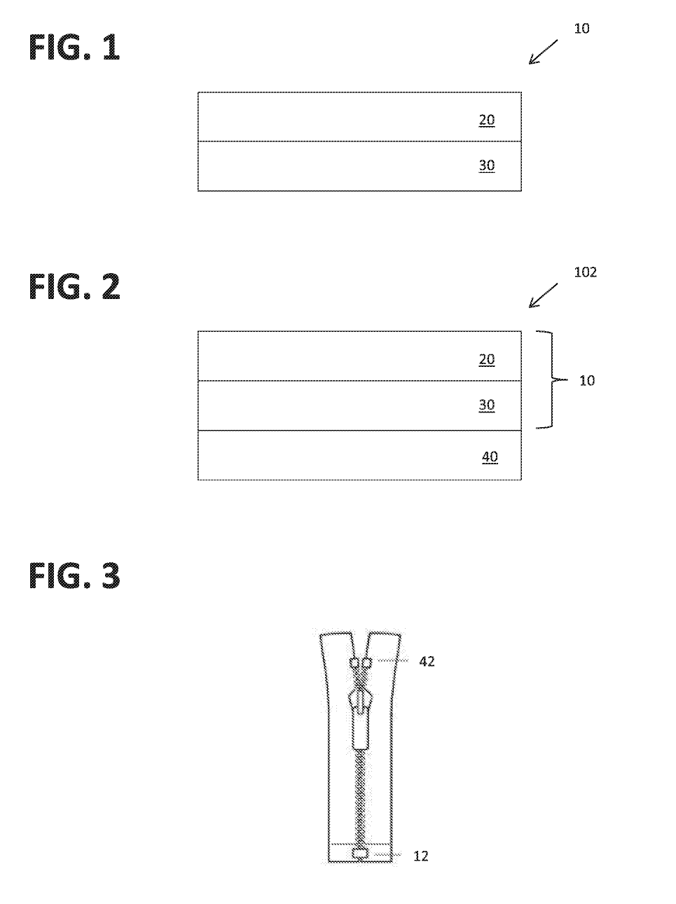

As illustrated in FIG. 1, the adhesive film 10 can have two layers including a barrier layer 20 and an adhesive layer 30 overlying the barrier layer 20. In an embodiment, the adhesive layer can have a bonding temperature that is lower than the heat resistance layer.

The barrier layer can provide the adhesive film with a barrier property, such as flame resistance, heat resistance, radiation resistance, tear resistance, puncture resistance, additional support for gripping, improved stiffness of underlying substrate, or any combination thereof. In a particular embodiment, the barrier layer can provide the adhesive film with a heat resistance at a temperature of 260° C. for at least 5 min.

In an embodiment, the barrier layer can be a high temperature barrier layer. As the melting temperature of the barrier layer increases, the barrier layer can better withstand high temperature environments. For example, the barrier layer can be formed of a material having a melting temperature of at least 230° C., or at least 240° C., or at least 250° C., or at least 260° C. In particular embodiments where the adhesive film will need to pass the High Temperature Test described herein, the barrier layer can be formed of a material having a melting temperature of at least 270° C., or at least 280° C., or at least 290° C. In an embodiment, the barrier layer can have a melting temperature of at most 500° C., or at most 450° C., or at most 400° C.

In an embodiment, the barrier layer can be a high density barrier layer, as opposed to an expanded, porous layer. As the density of the barrier layer increases, the barrier layer can better contain the adhesive layer in high temperature environments. For example, the barrier layer can have a density of at least 1 gram per centimeter cubed (g/cm³), or at least 1.5 g/cm³, or at least 2 g/cm³. In an embodiment, the density of the barrier layer can be at most 3 g/cm³. In a particular embodiment, the barrier layer is a sintered barrier layer.

In an embodiment, the barrier layer can have a relatively high Young's modulus as compared to the adhesive layer. If the Young's modulus of the barrier layer is too low, the barrier layer may not be able to provide the appropriate barrier properties. For example, the barrier layer can have a Young's modulus of at least 0.1 GPa, or at least 0.3 GPa, or at least 0.5 GPa, at a temperature of 25° C. If the Young's modulus of the barrier is too high, the barrier layer may not provide the appropriate flexibility depending on the particular use of the adhesive film. In an embodiment, the barrier layer may have a Young's modulus of at most 12 GPa, or at most 11 GPa, or at most 10 GPa.

In an embodiment, the barrier layer can include a polymer. The polymer can include a thermoplastic polymer, a thermoset polymer, or a combination thereof. In a particular embodiment, the polymer can include a fluoropolymer, a nitrogen-containing polymer, a polyester, a polyurethane, a polysulfone, or any combination thereof.

The fluoropolymer can include a perfluoropolymer. The fluoropolymer can include a homopolymer, a copolymer, a terpolymer, or a polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. In a particular embodiment, the fluoropolymer includes a polytetrafluoroethylene (PTFE). A further exemplary fluoropolymer can include a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), a polychlorotrifluoroethylene (PCTFE), a poly vinylidene fluoride (PVDF), a terpolymer including tetrafluoroethylene, hexafluoropropylene, and vinylidenefluoride (THV), or any blend or any alloy thereof. An exemplary fluoropolymer film can be skived or extruded.

In an embodiment, the nitrogen-containing polymer can include a polyamide, a polymer containing a repeating amide. The polyamide can be an aliphatic polyamide, a semi-aromatic polyamide, an aromatic polyamide, or any combination thereof. In a particular embodiment, the aliphatic polyamide can include, for example, a polyamide 66; a polyamide 46; or any combination thereof. In a particular embodiment, the semi-aromatic polyamide can include a polyphthalamide, such as, for example, a polyamide 6T (where “T” refers to a terephthalic acid); a polyamide 6T/66; a polyamide 6T/DT; a polyamide 6T/6I (where “I” refers to isophthalic acid); a polyamide 6T/6I/66 or any combination thereof.

In an embodiment, the polyester can include an aliphatic polyester, a semi-aromatic polyester, an aromatic polyester, or any combination thereof.

In an embodiment, the barrier layer can have a generally consistent cross-section. As used herein, the term generally consistent cross-section refers to generally maintaining one or more properties throughout the entire cross-section of the barrier layer. For example, the barrier layer can have a generally consistent density throughout the cross-section. In an embodiment, the density of the barrier layer in a 1 cm³ region of the barrier layer does not change by more than 10%, or by more than 5%, or by more than 1%, as compared to any other 1 cm³ region within the barrier layer. In a further embodiment, the composition of barrier layer is maintained throughout the cross-section. For example, in an embodiment, the concentration of the barrier layer material having the highest concentration in a 1 cm³ region of the barrier layer does not change by more than 10%, or by more than 5%, or by more than 1%, as compared to any other 1 cm³ region within the barrier layer.

In an embodiment, the barrier layer can be treated to improve adhesion of the fluoropolymer layer to the layer it directly contacts. In an embodiment, the treatment may include chemical modifications to improve adhesion of the fluoropolymer layer to the layer it directly contacts. In another embodiment, the treatment may include mechanical modifications to improve adhesion of the fluoropolymer layer to the layer it directly contacts.

The barrier layer can have a thickness within a particular range that provides sufficient support and heat transfer for the adhesive layer. In a particular embodiment, if the barrier layer has a thickness of less than about 0.05 mm, the strength of the barrier layer begins to diminish. For example, the barrier layer can have a thickness of at least 0.05 mm, or at least 0.06 mm, or at least 0.07 mm. However, if the barrier layer has a thickness greater than about 0.25 mm, the stiffness of the barrier layer would become too great that it would not be conformable to the substrate layer (discussed below) and the heat transfer to the adhesive layer would diminish as well. For example, the barrier layer can have a thickness of no greater than 0.25 mm, or no greater than 0.24 mm, or no greater than 0.23 mm. The barrier layer can provide the adhesive film with an adhesive property. In a particular embodiment, the adhesive film can be selected for adhesion to a particular substrate, such as a film or a fabric.

In an embodiment, the adhesive layer is heat sensitive adhesive material that forms a bond when heat is applied to adhesive material and the adherend. In a particular embodiment, as the melting temperature of the adhesive layer decreases, the adhesive layer can more readily form bonds at a lower temperature. For example, the adhesive layer can be formed of a material having a melting temperature of at most 200° C., or at most 190° C., or at most 180° C., or at most 170° C. In particular embodiments where the adhesive film will need to pass the Bonding Performance Test described herein, the adhesive layer can be formed of a material having a melting temperature of at most 160° C., or at most 150° C., or at most 145° C. In an embodiment, the barrier layer can have a melting temperature of at least 100° C., or at 110° C., or at least 120° C.

In an embodiment, the barrier layer can include a polymer. The polymer can include a thermoplastic polymer, a thermoset polymer, or a combination thereof. In a particular embodiment, the polymer can include a nitrogen-containing polymer, an ethylene-vinyl acetate copolymer, a polyolefin, a polyurethane, a styrene block copolymer, a fluoropolymer, or any combination thereof. In a more particular embodiment, the nitrogen-containing polymer can include a polyamide. In an embodiment, the polyamide can interact with the barrier layer to retain its dimensions even at temperatures above the melting temperature for the polyamide. For example, the polyamide NAF-610 from Adhesive Films, Inc., available at Pine Brook, New Jersey, USA, can be used.

In an embodiment, the adhesive layer can have a thickness of at least 0.01 mm, or at least 0.3 mm, or at least 0.5 mm. In a further embodiment, the adhesive layer may have a thickness of at most 0.15 mm, or at most 0.13 mm, or at most 0.11 mm.

An adhesive film can be formed from the adhesive layer overlying the barrier layer. In an embodiment, the adhesive film can be formed by lamination, extrusion coating, co-extrusion, or the like. In a particular embodiment, the adhesive layer can be directly contacting the barrier layer. As discussed above, the surface of the barrier layer can be treated to improve adhesion between the barrier layer and the adhesive layer. In an embodiment, the adhesive film can include on the barrier layer and the adhesive layer. In other embodiments, additional layers can be added to the adhesive film, such as a reinforcement layer between the barrier and adhesive layers, or within the barrier layer, for example.

As mentioned previously, the adhesive film can be subjected to a Bonding Performance Test. The Bonding Performance Test is a measure of whether the adhesive film can form a bond at a given temperature. In particular, the Bonding Performance Test includes laminating the sample adhesive film to a flame resistant meta-aramid fabric, such as NOMEX (available from DuPont Protection Technologies in Richmond, Va., USA) under a pressure of 500 psi at a given temperature for 1 minute. The film/fabric laminate is cooled to a temperature of about 25° C. and subjected to a hand-peel test. If the adhesive film is not removed from the fabric by the hand-peel test, the adhesive film has a bonding performance at the given temperature. If the adhesive film is removed from the fabric by the hand-peel test, the adhesive film does not have a bonding performance at the given temperature. In an embodiment, the adhesive film has a bonding performance temperature of no greater than 200° C., or no greater than 190° C., or no greater than 180° C., or no greater than 170° C., as measured according to the Bonding Performance Test.

As mentioned previously, the adhesive film can be subjected to a Heat Resistance Test. The Heat Resistance Test is a measure of whether the adhesive film can be adhered to a substrate, immersed in a high temperature environment for a period of 5 minutes, and cooled to 25° C., without destroying the integrity of the adhesive film or the bond to the substrate. In particular, the Heat Resistance Test includes forming the film/fabric laminate as discussed in the Bonding Performance Test at a passing bonding temperature. The film/fabric laminate is placed in an oven at a given temperature for 5 minutes. If there is a change of no greater than 5% in width or length of the adhesive film, then the sample adhesive film has a heat resistance at the given temperature. If there is a change of greater than 5% in the length or width of the adhesive film, then the sample adhesive film does not have a heat resistance at the given temperature. In an embodiment, the adhesive film has a heat resistance temperature of at least 230° C., or at least 240° C., or at least 250° C., or at least 260° C., as measured according to the Heat Resistance Test.

In a particular embodiment, the adhesive film has a combination of the bonding temperature and the heat resistance temperature described above. Existing adhesive films can typically achieve one of bonding temperature or heat resistance but fail the other. For example, if the adhesive can form a bond at a lower temperature, then the heat resistance is reduced, whereas if the adhesive can resist high temperatures, then the bonding temperature is increased. However, the inventors have developed a unique, unexpected adhesive film that includes a synergistic combination of a barrier layer and an adhesive layer that can together achieve a relatively low bonding temperature and a relatively high heat resistance. Without being bound by any particular theory, the barrier layer in particular embodiments can stabilize the adhesive layer during the Heat Resistance Test so that the melted adhesive layer does not flow in the high temperature environment and can return to is general structure after cooled to a temperature of 25° C.

Adhesive films of made of the layers described above may have numerous applications. As illustrated in FIG. 2, an article 102 can include the adhesive film 10 coupled to a substrate layer 40. In an embodiment, the adhesive film and the substrate layer together can have a Young's modulus that is higher than the Young's modulus of the substrate layer alone. In a particular embodiment, the substrate layer 40 can be a film or a fabric. For example, the fabric can include natural fibers, synthetic fibers, or combination thereof. In an embodiment, the fibers may be in the form of a knit, laid scrim, braid, woven, or non-woven fabric. Manufacturing and materials selection flexibility imparted by a relatively bonding temperature coupled with the high temperature resistance is a novel contribution to many potential markets.

Particular applications can include, for example, uses when the properties such as low bonding temperature and high heat resistance are desired. In an embodiment, exemplary articles incorporating the adhesive film can include shelters, liners, protective gear, and clothing. The structure may also possess other properties desired for any particular application envisioned. In the particular embodiment illustrated in FIG. 3, the substrate can include a zipper tape 42 and the adhesive film 12 can be a reinforcement film applied to the zipper tape 42 to provide reinforcement to the structure.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

### Embodiment 1

An adhesive film comprising: a polymer barrier layer having a melting temperature of at least 230° C.; and a polyamide adhesive layer having a melting temperature of no greater than 200° C.

### Embodiment 2

An adhesive film comprising: a polymer barrier layer having a density of at least 1 g/cm³; and a polyamide adhesive layer having a melting temperature of no greater than 200° C., the polyamide adhesive layer directly contacting the high density thermoplastic barrier layer.

### Embodiment 3

An adhesive film comprising: a polymer barrier layer; and a polymer adhesive layer; wherein the adhesive film has a bonding performance temperature of no greater than 200° C. and a heat resistance temperature of at least 230° C.

### Embodiment 4

The adhesive film of any one of the preceding embodiments, wherein the bonding performance temperature is at least 190° C., or at least 180° C., or at least 170° C.

### Embodiment 5

The adhesive film of any one of the preceding embodiments, wherein the heat resistance temperature is at least 240° C., or at least 250° C., or at least 260° C.

### Embodiment 6

The adhesive film of any one of the preceding embodiments, wherein the barrier layer is a high density barrier layer.

### Embodiment 7

The adhesive film of any one of the preceding embodiments, wherein the barrier layer comprises a polymer, a thermoplastic polymer, or at least one of a fluoropolymer or a polyamide.

### Embodiment 8

The adhesive film of any one of the preceding embodiments, wherein the fluoropolymer comprises a perfluoropolymer, or a polytetrafluoroethylene.

### Embodiment 9

The adhesive film of any one of the preceding embodiments, wherein the barrier layer has a melting temperature of at least 250° C., or at least 270° C., or at least 290° C.

### Embodiment 10

The adhesive film of any one of the preceding embodiments, wherein the barrier layer has a thickness of at least 0.05 mm, or at least 0.06 mm, or at least 0.07 mm, or no greater than 0.25 mm, or no greater than 0.24 mm, or no greater than 0.23 mm.

### Embodiment 11

The adhesive film of any one of the preceding embodiments, wherein the Young's Modulus of the barrier layer is at least 0.1 GPa, or at least 0.3 GPa, or at least 0.5 GPa, or at most 12 GPa, or at most 11 GPa, or at most 10 GPa.

### Embodiment 12

The adhesive film of any one of the preceding embodiments, wherein the barrier layer has a uniform cross-section.

### Embodiment 13

The adhesive film of any one of the preceding embodiments, wherein the adhesive layer is directly contacting the barrier layer.

### Embodiment 14

The adhesive film of any one of the preceding embodiments, wherein the adhesive layer comprises a polyamide, an ethylene-vinyl acetate copolymer, a polyolefin, a polyurethane, a styrene block copolymer, a fluoropolymer, or any combination thereof.

### Embodiment 15

The adhesive film of any one of the preceding embodiments, wherein the adhesive layer comprises a polyamide.

### Embodiment 16

The adhesive film of any one of the preceding embodiments, wherein the adhesive layer has a melting temperature of no greater than 190° C., or no greater than 180° C., or no greater than 170° C.

### Embodiment 17

An article comprising: a substrate layer; and an adhesive film of any one of the preceding claims.

### Embodiment 18

The article of embodiment 17, wherein the Young's modulus of the substrate layer and the adhesive film is greater than the Young's modulus of the substrate layer alone.

### Embodiment 19

The article of any one of embodiments 17 and 18, wherein the substrate layer includes a film, a woven fabric, or a non-woven fabric.

### Embodiment 20

The article of embodiment 19, wherein the substrate layer comprises a polymer, or a thermoplastic polymer, or a polyamide.

### Embodiment 21

The article of any one of embodiments 17 to 20, wherein the substrate layer includes a zipper tape.

### Embodiment 22

The article of embodiment 21, wherein the zipper tape has a lower end and the adhesive film is a reinforcement film disposed on the lower end of the zipper tape.

The functions and advantages of these and other embodiments of the invention can be further understood from the example below. The following example illustrates the benefits and advantages of the systems and techniques of this specification but do not exemplify its full scope.

### Example

Samples of adhesive films having a barrier layer and an adhesive layer were tested to determine whether each sample could pass the Bonding Performance Test at a temperature of no greater than 170° C. and the Heat Resistance Test at a temperature of 260° C.

The composition of the barrier layer and the adhesive layer, as well as the results of the Bonding Performance Test and the Heat Resistance Test are provided below in Table 1.

TABLE 1

| | | DSC | | DSC | Bonding | Heat |
|---|---|---|---|---|---|---|
| | Barrier | MP | Adhesive | MP | Performance | Resistance |
| | Layer | (° C.) | Layer | (° C.) | Test | Test |
| Sample 1 | PA6T | 299 | NAF-610 | 140 | Pass | Pass |
| Sample 2a | Skived PTFE | 327 | NAF-610 | 140 | Pass | Pass |
| Sample 2b | Extruded PTFE | 327 | NAF-610 | 140 | Pass | Pass |
| Sample 3 | PA66 | 262 | N/A | N/A | Fail | Pass |
| Sample 4 | PA6T | 299 | N/A | N/A | Fail | Pass |
| Sample 5 | PA46 | 290 | N/A | N/A | Fail | Pass |
| Sample 6 | PA6T | 299 | PA66 | 255 | Fail | Pass |
| Sample 7 | PET | 260 | Phenolic | N/A | Fail | Fail |
| Sample 8 | Glass Fabric | N/A | Phenolic | N/A | Fail | Fail |
| Sample 9 | Glass Fabric | N/A | PA6 | 220 | Fail | Pass |
| Sample 10 | PA6T | 299 | PA6 | 220 | Fail | Pass |
| Sample 11 | Skived PTFE | 327 | PA6 | 220 | Fail | Pass |

According to the results in Table 1, only Samples 1, 2a and 2b were able to pass both the Bonding Performance Test at 170° C. and the Heat Resistance Test at 260° C.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An adhesive film comprising:
a polymer barrier layer having a melting temperature of at least 230° C.; and
a polyamide adhesive layer having a melting temperature of no greater than 200° C.

2. (canceled)

3. The adhesive film of claim 1, wherein the bonding performance temperature is at least 170° C.

4. The adhesive film of claim 1, wherein the polymer barrier layer is a high density barrier layer.

5. The adhesive film of claim 1, wherein the polymer barrier layer comprises a polymer, a thermoplastic polymer, or at least one of a fluoropolymer or a polyamide.

6. The adhesive film of claim 1, wherein the polymer barrier layer has a melting temperature of at least 250° C.

7. The adhesive film of claim 1, wherein the barrier layer has a thickness of at least 0.05 mm and no greater than 0.25 mm.

8. The adhesive film of claim 1, wherein the Young's Modulus of the polymer barrier layer is at least 0.1 GPa and at most 12 GPa.

9. The adhesive film of claim 1, wherein the polymer barrier layer has a uniform cross-section.

10. The adhesive film of claim 1, wherein the polymer adhesive layer is directly contacting the polymer barrier layer.

11. The adhesive film of claim 1, wherein the polymer adhesive layer comprises a polyamide, an ethylene-vinyl acetate copolymer, a polyolefin, a polyurethane, a styrene block copolymer, a fluoropolymer, or any combination thereof.

12. An article comprising:
a substrate layer; and
an adhesive film comprising a polymer barrier layer having a melting temperature of at least 230° C.; and a polyamide adhesive layer having a melting temperature of no greater than 200° C.

13. The article of claim 12, wherein the Young's modulus of the substrate layer and the adhesive film is greater than the Young's modulus of the substrate layer alone.

14. The article of claim 12, wherein the substrate layer includes a film, a woven fabric, or a non-woven fabric.

15. The article of claim 14, wherein the substrate layer comprises a polymer, or a thermoplastic polymer, or a polyamide.

16. An adhesive film comprising:
a polymer barrier layer; and
a polymer adhesive layer;
wherein the adhesive film has a bonding performance temperature of no greater than 200° C. and a heat resistance temperature of at least 230° C.

17. The adhesive film of claim 16, wherein the bonding performance temperature is at least 170° C.

18. The adhesive film of claim 16, wherein the polymer barrier layer is a high density barrier layer.

19. The adhesive film of claim 16, wherein the polymer barrier layer comprises a polymer, a thermoplastic polymer, or at least one of a fluoropolymer or a polyamide.

20. The adhesive film of claim 16, wherein the polymer barrier layer has a melting temperature of at least 250° C.

21. The adhesive film of claim 16, wherein the barrier layer has a thickness of at least 0.05 mm and no greater than 0.25 mm.
